(19) United States
(12) Patent Application Publication
(10) Pub. No.: US 2006/0270330 A1
(43) Pub. Date: Nov. 30, 2006

(54) LINEAR DRIVE UNIT

(76) Inventor: Kurt Schmid, Bunde (DE)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/380,680

(22) Filed: Apr. 28, 2006

(30) Foreign Application Priority Data
Apr. 28, 2005 (DE) 102005020184.9

(51) Int. Cl. A22B 3/06

(52) U.S. Cl. 452/58

(57) ABSTRACT

The invention relates to a linear drive unit with a linear stroke (h) for adjusting parts mounted in movable fashion, particularly in items of furniture, having a housing (2), a transmission unit (3) driven by a motor and mounted in the housing (2), through which a torque of a first transmission element (4) can be converted into a linear movement of a thrust element (5), where the thrust element (5) is mounted coaxially and movably relative to the first transmission element (4), and is provided with an external thread (6) that engages an internal thread (7) provided on the first transmission element (4), and having two coupling elements (8, 9) for coupling the linear drive unit (1) to the item of furniture, where a first coupling element (8) is connected to the housing (2), and a second coupling element (9) to an end of the thrust element (5) designed as a coupling end (10), and where at least the coupling end (10) of the thrust element (5) passes out of the housing (2) through an outlet opening (11). According to the invention, the first transmission element (4) is designed as a hollow, cylindrical rotary body with an input section (12) and an output section (13). Furthermore, the output section (13) is axially remote or offset from the input section (12).

The invention relates to a linear drive unit with a linear stroke travel for adjusting parts mounted in movable fashion, particularly in items of furniture, having a housing, a transmission unit driven by a motor and mounted in the housing, through which a torque of a first transmission element can be converted into a linear movement of a thrust element, where the thrust element is mounted coaxially and movably relative to the first transmission element, and is provided with an external thread that engages an internal thread provided on the first transmission element, and having two coupling elements for coupling the linear drive unit to the item of furniture, where a first coupling element is connected to the housing, and a second coupling element to an end of the thrust element designed as a coupling end, and where at least the coupling end of the thrust element passes out of the housing through an outlet opening.

For example, known linear drive units of the type indicated in the opening paragraph display a driven gearwheel as the first transmission element, the internal thread of which engages the external thread of a spindle designed as the thrust element, said spindle being mounted in the housing in non-rotating fashion. The disadvantage of these drive units is, however, the necessarily large assembly dimension with a relatively short stroke, this resulting in a correspondingly large dead length as the difference between assembly dimension and stroke.

The object of the invention is thus to provide a linear drive unit that features an improved ratio of assembly dimension to stroke, and displays a compact design.

According to the invention, the object is solved in that the first transmission element is designed as a hollow, cylindrical rotary body with an input section and an output section, and in that the output section is axially remote or offset from the input section.

The axially remote or offset arrangement of the input section and the output section of the hollow, cylindrical rotary body results in a particularly small assembly dimension with maximum stroke and a small dead length. The greater the distance between the two sections, the smaller the dead length can become in relation to the maximum stroke. In this context, the dead length of the linear drive unit according to the invention can be one-third smaller than with conventional linear drive units. In the linear drive unit according to the invention, the greater stiffness of hollow, cylindrical bodies compared to customary spindles additionally makes it possible to use longer rotary bodies. The spindle can easily be shortened to a required length for installation in a specific item of furniture. The input section and the output section can also be arranged in an offset position relative to each other.

In an advantageous development, at least part of the output section of the rotary body can extend from the housing through the outlet opening. This further maximizes the stroke length. For installation in a specific item of furniture, the rotary body can be cut to a length adapted to the item of furniture. Furthermore, compared to a thrust element pushing through the outlet opening, this permits better sealing of the outlet opening against the environment, as well as easier lubrication of the rotating rotary body. Lubrication itself can be accomplished by means of axial lubricating grooves that contain lubricant and are arranged at intervals around the circumference of the inner side of the outlet opening.

Advantageously, the input section can be located on one end of the rotary body, and the output section on an end of the rotary body opposite to said end. This achieves a maximum stroke length via the rotary body.

It is considered to be an advantage if the thrust element is located remotely from the input section of the rotary body. This permits stable mounting of the input section in the housing.

An advantageous development can consist in the thrust element being located away from the housing in non-rotating fashion in the first transmission element. In this context, the moving part of the item of furniture can act via the second coupling element in such a way that the thrust element is mounted in non-rotating fashion via the moving part. The non-rotating nature of the thrust element can, for example, be realized on an adjustable head section, connected in pivoting fashion to a bed frame, in which context the housing is connected to the bed frame in non-rotating fashion. The design of the linear drive unit can be used to advantage in cases where the necessary stroke is to be generated remotely from the housing. To this end, the first transmission element, which is designed as a hollow body and has its output side in the housing, can extend to the location where the stroke is to be generated, in which context the hollow body displays greater strength compared to a spindle used in the prior art, this making it possible to transmit relatively higher torques.

In a preferred development, the thrust element is designed as a spindle, mounted in non-rotating and axially movable fashion in the housing. To realize the non-rotating nature of the spindle, it can display an internal hole of non-circular cross-section, extending along its longitudinal axis, into which a rotation-preventing component projects that is adapted to the internal hole and connected to the housing in non-rotating fashion. The rotation-preventing component can be connected to the housing in non-rotating fashion in reference to its longitudinal axis in the internal hole. Since the rotation-preventing component is adapted to the internal hole and slides in it, not only can a non-rotating arrangement of the spindle be achieved, but also axial guidance of the spindle by the rotation-preventing component. Ultimately suitable as rotation-preventing components are all components that have, for example, a polygonal or oval cross-section and therefore cannot be rotated in a matching internal hole, in which context they contact the inner side of the internal hole at two points, at least over part of the circumference, the distance between which, passing through the mid-point, is greater than the smaller diameter of the internal hole, and that furthermore contact the internal hole in longitudinally sliding fashion. In this context, preference is given to a simple solution, in which the internal hole can display a roughly oval cross-section, and the rotation-preventing component can be designed as a wire, particularly a welding rod, whose end projecting into the internal hole is bent over and passed back over itself. In this context, the bent-over end should display a roughly oval cross-section, adapted to the internal hole. The spindle can preferably be made of aluminum section, which can be cut off to the required length. The external thread can be rolled or cut into the spindle.

For mounting in non-rotating fashion, the end of the wire facing away from the output section and leading out of the internal hole can be bent over at an angle, preferably at right angles, and connected to the housing via a provided wire retainer adapted to the wire cross-section. The wire retainer can be designed as a hole, into which at least part of the bent-over end of the wire can be inserted.

In a preferred embodiment, the input section of the rotary body can be mounted in a fixed bearing in axially immovable fashion. As a result, the area in which the torques are transmitted via a relatively short section can be mounted particularly stably, this having a favorable influence on the quiet running of the linear drive unit. The result of this is that the other bearing arrangement, which is provided by or in the outlet opening, is designed as a movable bearing. To pass the rotation-preventing component through the fixed bearing, the rotary body can display a journal that passes coaxially through the fixed bearing, is adapted to the inside diameter of the fixed bearing, and has a central, internal hole. In this context, the section of the journal passing through the fixed bearing can be connected to the side of the fixed bearing facing away from the output section via a riveted joint. On the side of the fixed bearing facing towards the output section, the rotary body can run up against a stop surface provided. Instead of a journal, it is also possible to provide a coaxially arranged banjo bolt, which connects the rotary body to the fixed bearing in immovable fashion, and the internal hole of which serves to pass through the rotation-preventing component. A journal through which a banjo bolt passes can also be provided.

The rotary body can generally be designed as a rotationally symmetrical hollow body with an internal thread for engaging the external thread of the spindle.

An embodiment in which the rotary body is designed as a one-piece tubular nut is preferred. The internal thread in the output section of the tubular nut can preferably extend up to the input section. This results in particularly good spindle guidance over the output section.

If provision is made for the rotary body to extend from the housing through the outlet opening, the tubular nut can display a tubular nut head that is located outside the housing and a short distance from the face of the outlet opening. This makes it possible to achieve further stabilization of the rotatable mounting of the rotary body in the housing.

In another preferred embodiment, the rotary body can be designed as a tube section. The tube section itself can be manufactured from an aluminum tube that can be cut off to a required tube section length for installation.

One or both ends of the tube section can display a threaded bush fitted on the face end. For non-rotating and non-sliding fastening of the threaded bush on the tube section, the threaded bush can be screwed onto the end of the tube section. To this end, the threaded bush can display an externally threaded section that can be screwed into an internally threaded section of the tube section that is provided at the free end of the tube section.

For fixing on the tube section, the threaded bush can display a bush head with an outside diameter that is greater than, or equal to, the outside diameter of the tube section, where the bush head can be axially guided into a stop position against the face end of the tube section by screwing the threaded bush onto the tube section. To avoid releasing of the threaded bush from the tube section as a result of its screwed connection to the tube section loosening, provision can be made for at least one axial pin or the like to be provided, being located in a face-end, axial hole designed as a locking hole, where the locking hole extends in aligned fashion from the bush head into the shell of the tube section when in locking position. This makes it possible to prevent turning of the threaded bush out of its stop position, and the resultant loosening of the screwed connection. At the same time, this prevents axial displacement, since rotation of the threaded bush results in axial displacement in the event of a screwed connection. If provision is made for several axial locking holes with inserted axial pins, they should expediently be located on a circumferential radius roughly equal to the mean circumferential radius of the tube section.

The threaded bush is preferably manufactured as a plastic injection molding or a zinc die casting. In this context, the axial locking hole can already be produced by the injection or die casting mold in the form of a shorter pilot hole, preferably designed as a blind hole. Once the threaded bush has been screwed onto the tube section up to the stop position, where the bush head lies against the face end of the tube section, the pilot hole can be extended into the shell of the tube section to produce the locking hole. The axial pin of the locking hole can subsequently be knocked in such that it connects the threaded bush to the tube section via the locking hole and lies in the locking hole under tension. The locking hole can also be sunk into the shell of the tube section and simultaneously into the mutually engaging threaded sections of the tube section and the threaded bush. When the axial pins are inserted, the externally threaded section and the internally threaded section can thus additionally be blocked, thereby achieving more stable fixing of the threaded bush on the tube section. In a different procedure, the pilot hole can also be sunk into the threaded bush following prior manufacture of the threaded bush, and before mounting of the threaded bush on the tube section.

In a preferred embodiment of the rotary body, the threaded bush fitted on the one end of the tube section can display an internal thread to form the output section. As a result, there is no need for an internal thread that would have to be produced by a complex process directly in the tube section.

In an embodiment of the rotary body that is likewise preferred, since it is simple and easier to manufacture in terms of production engineering, the threaded bush fitted on the one end of the tube section can be designed as a bearing section.

To limit the stroke in defined manner, a limit switch actuator for controlling the stroke travel can be provided. The limit switch actuator can be movable on the rotary body over a switching path limited by limit switches, the length of the switching path being adjustable by positioning the limit switches.

The limit switch actuator can preferably display a threaded bush with an internal thread, by means of which the threaded bush engages an external thread provided on the rotary body, and be guided on the rotary body in non-rotating fashion. The pitch of the two threads, that of the internal thread of the threaded bush and that of the external thread of the rotary body, determines the proportion of the path traveled by the limit switch actuator over its switching path per revolution of the rotary body. In the case of relatively long stroke lengths, for example, a transmission ratio between stroke and switching path can be provided by the internal thread of the threaded bush having a smaller pitch than the threaded connection between the internal thread of the rotary body and the external thread of the spindle, in order to obtain a correspondingly shorter switching path.

The limit switch actuator can preferably display a projection that extends radially outwards from the threaded bush and whose free end is guided axially in a guide provided. The guide can be provided with an axial guide groove, and the projection can display a cross-section with two sides that run parallel to each other and are designed as guiding sides lying laterally against the inner walls of the guide groove in axially movable fashion. Axial guidance of the limit switch actuator over the switching path can be achieved as a result. In a development, the limit switch actuator can display two projections, these being located opposite each other and extending radially outwards on the threaded bush, and the end of each being guided in the axial guide groove. Improved mounting of the rotary body in the housing of the linear drive unit can simultaneously be achieved in this way.

The projection preferably displays, laterally and in both directions of the switching path, a side face for acting on the limit switch that is arranged at an acute angle to the switching path. As a result, the side face in each case forms an inclined plane relative to the switching path. The limit switch itself can be designed as a pressure-operated switch with a button that slides over the inclined plane when the side faces travel over the button and is pressed towards a position triggering a switching pulse. This can be accomplished by the button being pressed into the limit switch. The button is preferably spring-mounted in the limit switch, the button being moved against spring resistance into a position triggering the switching pulse. When the side face moves off, the button is returned to its starting position by the stored spring energy. The inclination of the side face relative to the switching path can be used to set the path section of the switching path that the limit switch actuator has to cover in order to trigger a switching pulse.

For setting a specific stroke, the limit switches can in each case be fixable in any desired position on the switching path by means of an adjusting device provided. To this end, the limit switches can be guided in an axial guide extending over the switching path. The guide can display a slit. The limit switches can in each case be fixable in the slit to this end. A screw connection can be provided for fixing the limit switches. For this purpose, the slit width can expediently be equal to the minor diameter of the screw of the screw connection, such that the screw is fixed in the slit when screwed into the slit.

In a preferred development of the second coupling element, a fork head or a lug with a connecting element for connection to the item of furniture can be provided, being fastened to the coupling end in non-rotating and non-sliding fashion. To prevent axial sliding, the face end of the second coupling element can be screwed onto the coupling end. To this end, the coupling element can comprise a fastening section with a hollow cylinder displaying an internal thread that engages an external thread provided on the end of the coupling end, where the face end of the fastening section can be guided into a stop position against the coupling end. To prevent loosening of the screwed connection between coupling end and second coupling element, a dowel pin can be passed through a radial opening provided in the spindle and the coupling element, connecting the spindle and the coupling element to each other when in a locking position. Instead of using a screwed connection with a locking device, the second coupling element can also be welded to the coupling end.

In a development, the coupling end can be provided with a connecting opening for accommodating a bolt or the like of the item of furniture. Said opening should preferably run perpendicular to the longitudinal axis of the thrust element, or perpendicular to the stroke. As with the outlet opening, lubrication can also be provided here. To this end, lubricating grooves running axially to the connecting opening and containing lubricant can be located at intervals around the circumference of the inner side of the connecting opening.

In a preferred development of the linear drive unit, the input side of the first transmission element can be driven by a second transmission element, which is arranged coaxially to the first transmission element and which furthermore overlaps the first transmission element, at least over an end section, and is connected to the first transmission element in non-rotating fashion. The overlap at the end promotes the compact design of the linear drive unit. In this context, for secure fixing on the first transmission element, the second transmission element can display an internal thread that engages an external thread of the first transmission element. The second transmission element can, for example, be designed as a gearwheel designed as a worm wheel, which is engaged by a worm connected to a shaft of the motor, where the axis of rotation of the worm is arranged parallel to the shaft of the motor and at an angle greater than 0° to the axis of rotation of the worm wheel. The angle is preferably 90°, such that the worm wheel and the worm are positioned at right angles to each other. As a result, the motor can be arranged at right angles to the longitudinal axis of the linear drive unit, or to the stroke of the linear drive unit, this further improving the compact design of the linear drive unit. The motor can be located in a common housing with the other parts of the linear drive unit, except for the parts of the linear drive unit extending from the housing. As a result of the motor being arranged at right angles to the first transmission element, or to the worm wheel, the motor can advantageously be positioned remotely from the two coupling elements and pointing away from them. As a result, the motor cannot have an interfering effect on the parts that are mounted movably for adjustment and coupled to the coupling elements.

The invention is explained in more detail below on the basis of two practical examples and an associated drawing. The Figures show the following:

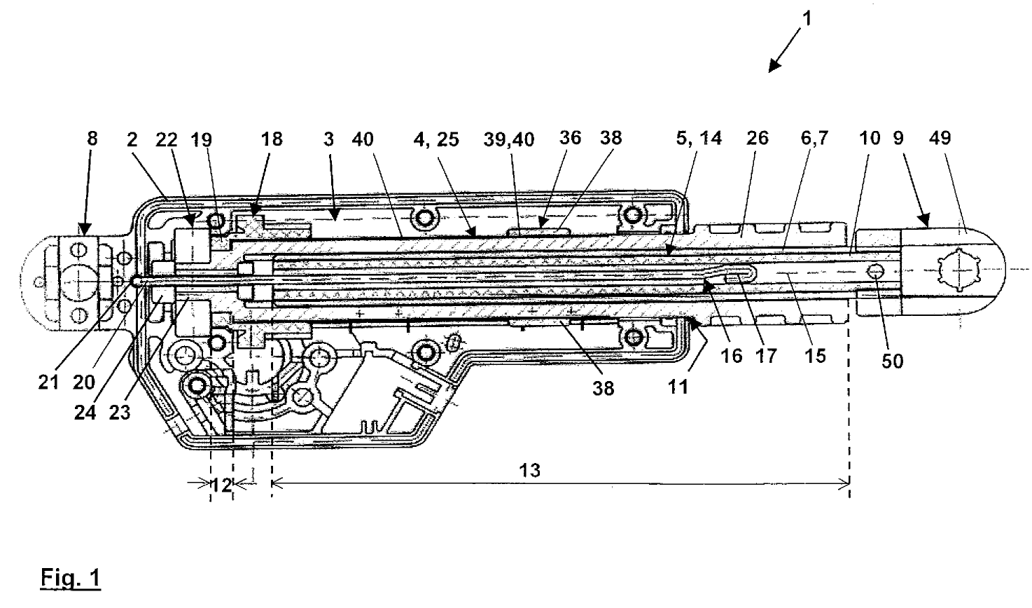

FIG. 1 A longitudinal section of a first embodiment of a linear drive unit, where the front housing half is removed,

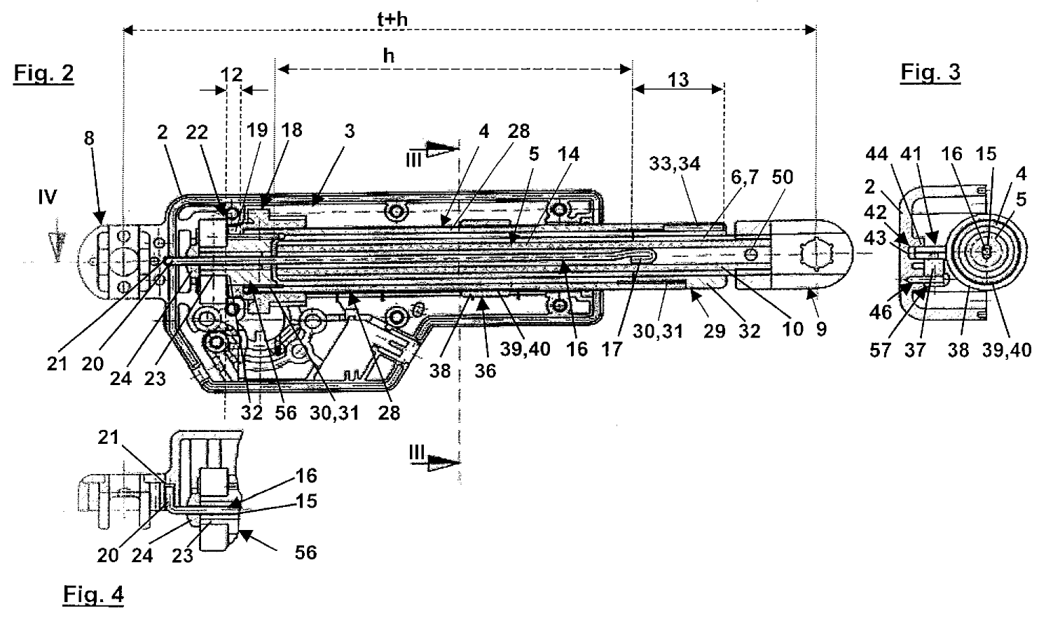

FIG. 2 A longitudinal section of a second embodiment of a linear drive unit, where the front housing half is removed,

FIG. 3 A cross-section along line III-III in FIG. 2,

FIG. 4 A partial section according to partial section IV in FIG. 2,

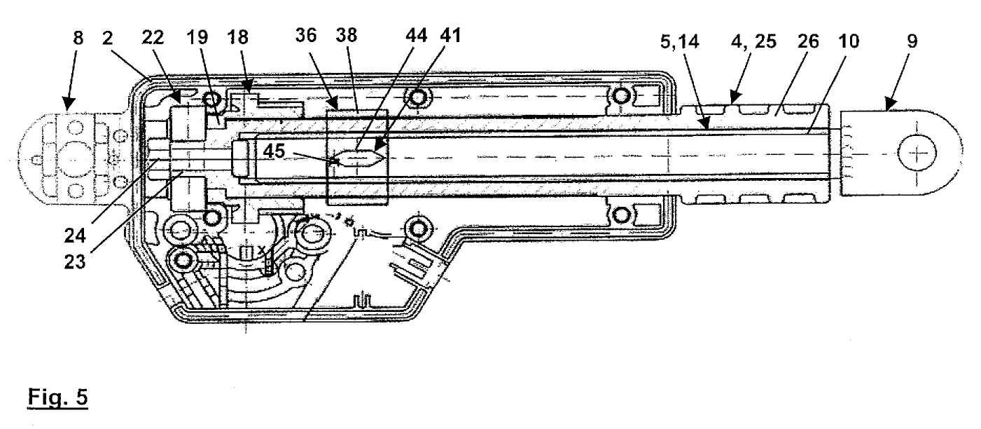

FIG. 5 A longitudinal section of the first embodiment of the linear drive unit, with removed front housing half and the rotary body in a sectional view,

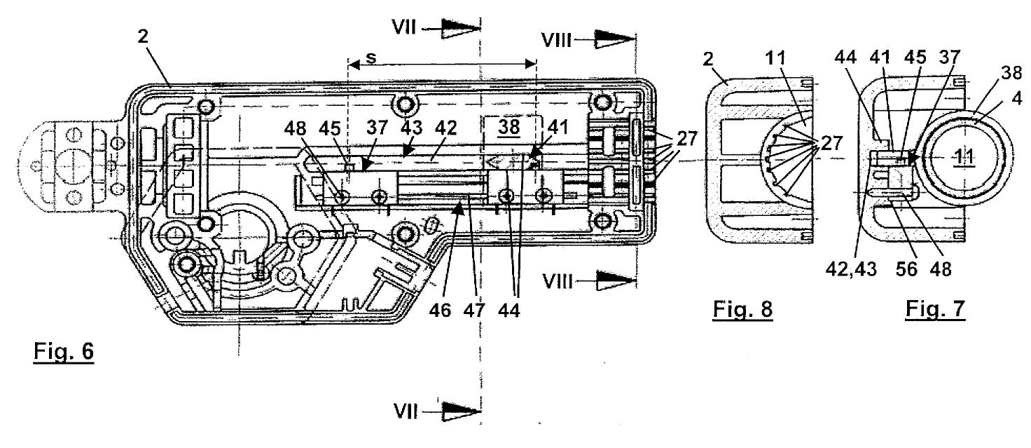

FIG. 6 A longitudinal section according to FIG. 1 and FIG. 2, but without the transmission elements and the thrust element,

FIG. 7 A cross-section along line VII-VII in FIG. 6, but with the rotary body,

FIG. 8 A cross-section along line VIII-VIII in FIG. 6, but with the rotary body,

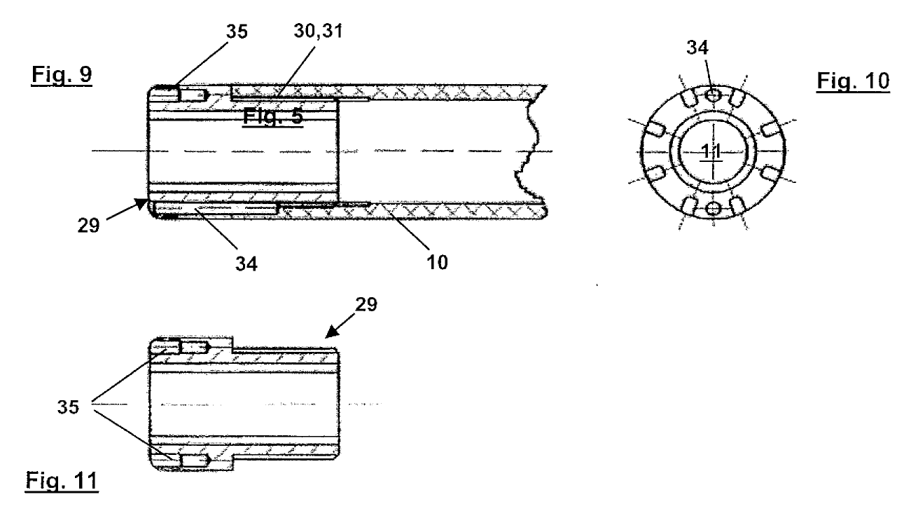

FIG. 9 A partial longitudinal section with an output section according to FIG. 2, with a threaded bush screwed in at the end,

FIG. 10 A face-end view of the output section according to FIG. 9,

FIG. 11 A longitudinal section of the threaded bush, prior to being screwed into the output section,

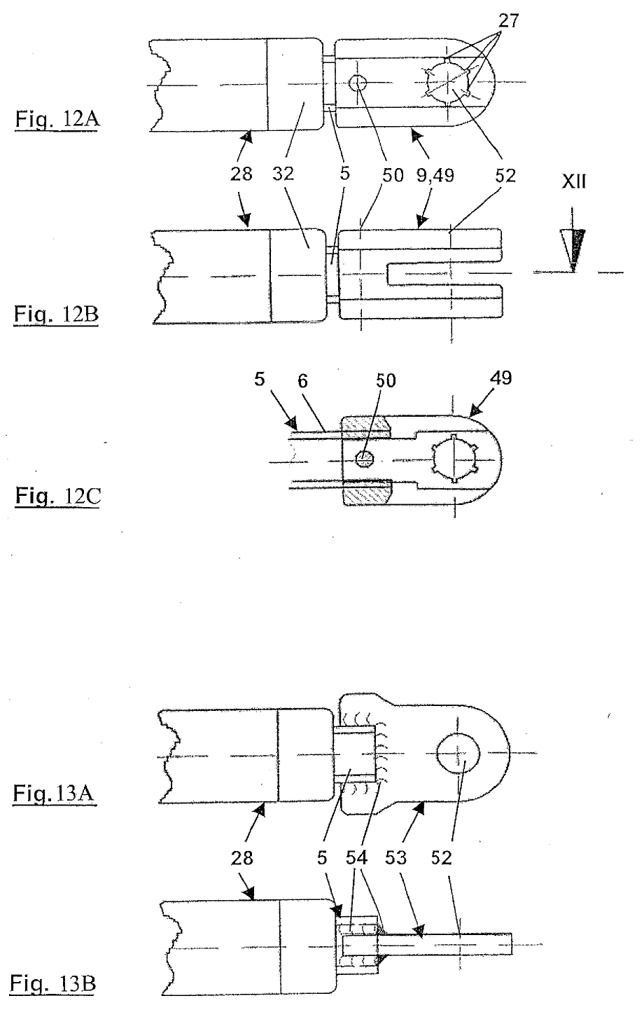

FIGS. 12 a to c Side views and a partial longitudinal section of the output section, with the second coupling element in a first embodiment,

FIGS. 13 a and b Side views of the output section, with the second coupling element in a second embodiment,

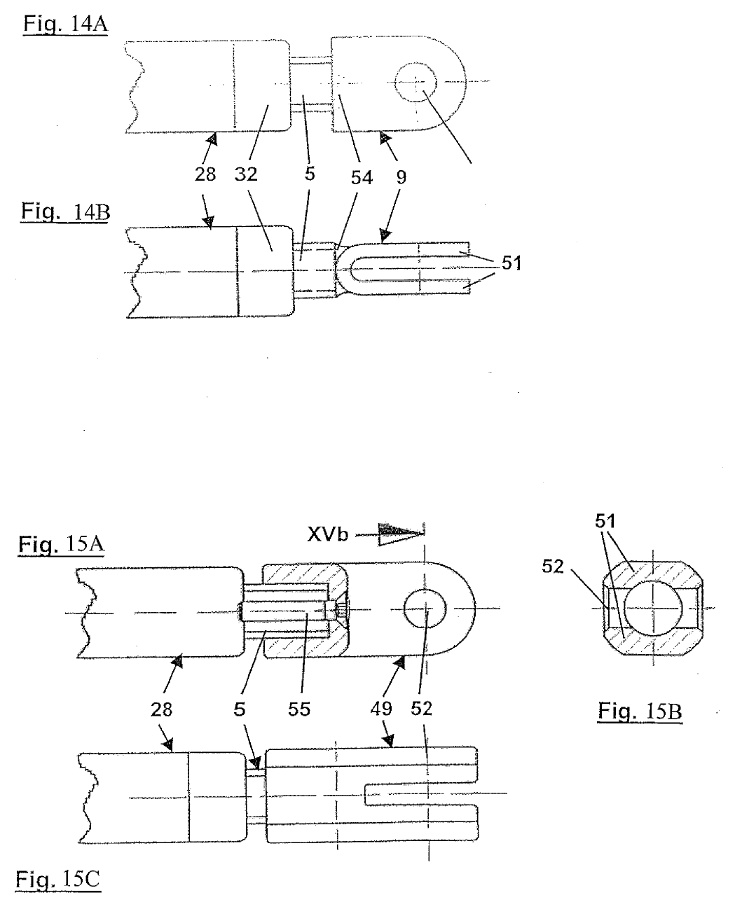

FIGS. 14 a and b Side views of the output section, with the second coupling element in a third embodiment, and

FIGS. 15 a to c Side views and sectional views of the output section, with the second coupling element in a fourth embodiment.

FIGS. 1 to 15 show different views and partial views of two different practical examples of a linear drive unit 1 with a linear stroke h for adjusting movably mounted parts (not shown), especially in items of furniture. Linear drive unit 1 displays a housing 2 and a transmission unit 3, which is driven by a motor (not shown) and mounted in housing 2, and by means of which the torque of a first transmission element 4 can be converted into a linear movement of a thrust element 5. Thrust element 5 is mounted coaxially and movably relative to first transmission element 4. Thrust element 5 displays an external thread 6, which engages an internal thread 7, provided on first transmission element 4. Linear drive unit 1 is provided with two coupling elements 8, 9 for coupling linear drive unit 1 to the item of furniture (not shown), where first coupling element 8 is connected to housing 2, and second coupling element 9 to an end of thrust element 5 designed as coupling end 10. Coupling end 10 projects from housing 2 through an outlet opening 11. FIG. 2 additionally indicates the dead length t and the stroke, where dead length t is taken to be the dimension resulting from the difference between the total length of linear drive unit 1 between the two coupling elements 8, 9 in non-extended state and the maximum stroke h.

First transmission element 4 is designed as a hollow, cylindrical rotary body with an input section 12 and an output section 13, where output section 13 is located in an axially remote position from input section 12. Furthermore, thrust element 5 is remote from input section 12 of first transmission element 4. Input section 12 is located on one end of the rotary body, and output section 13 on an end of the rotary body opposite said end, where part of output section 13 of the rotary body extends from housing 2 through outlet opening 11.

Thrust element 5 is designed as a spindle 14, which is mounted in non-rotating and axially movable fashion in housing 2. As can particularly be seen in FIG. 3, which is a cross-sectional view along line III-III in FIG. 2, spindle 14 displays an internal hole 15 with an oval cross-section, running in its longitudinal axis. Inserted in internal hole 15 is a rotation-preventing component in the form of a wire 16, end 17 of which reaches into internal hole 15 and is bent over and passed back over itself. As a result, bent-over end 17 displays a roughly oval cross-section, adapted to internal hole 15, as can particularly be seen in FIGS. 1 to 3.

On the input side, first transmission element 4 is driven by a second transmission element, designed as worm wheel 18, which is arranged coaxially to first transmission element 4. Worm wheel 18 overlaps the end of first transmission element 4, and is connected in non-rotating fashion to first transmission element 4 in input section 12 of first transmission element 4. To this end, the side of worm wheel 18 facing the lateral area of first transmission element 4 displays squares 19, which are distributed evenly over the circumference, run radially inwards, and transmit the rotary movement of worm wheel 18 directly to first transmission element 4. Worm wheel 18 belongs to a worm gear unit (not shown), which permits arrangement of the motor (not shown) perpendicular to the stroke h on housing 2 of linear drive unit 1, this making it possible to achieve a particularly compact design of linear drive unit 1.

At its end 20 emerging from internal hole 15, wire 16 is bent over roughly at right angles and mounted in a wire retainer 21, provided in housing 2, in a manner preventing rotation about the axis of rotation of linear drive unit 1. Together with worm wheel 18, the input end of first transmission element 4 is mounted in a fixed bearing 22, via a journal 23 in the first practical example of linear drive unit 1, and via a threaded bush 56 with journal 23 in the second practical example of linear drive unit 1. Journal 23 displays an interior space 15 for accommodating a banjo bolt 24, which firmly connects the rotary body to fixed bearing 22. Interior space 15 of banjo bolt 24 is used for insertion of wire 16 and, in contrast to interior space 15 of spindle 14, is of circular design in this instance. Coaxially arranged banjo bolt 24 connects the rotary body to fixed bearing 22.

The two practical examples of linear drive unit 1 essentially differ as regards the design of first transmission element 4. The first practical example of the linear drive unit, illustrated in FIGS. 1 and 5, displays a rotary body in the form of a one-piece tubular nut 25, the internal thread of which extends up to threaded bush 23. This achieves particularly good spindle guidance. On its end extending through outlet opening 11 in housing 2, tubular nut 25 displays a tubular nut head 26 with a larger diameter than the remainder of tubular nut 25. Tubular nut head 26 is separated from the outer side of outlet opening 11 by a short distance. As a result, output section 13 is, as also in the second practical example, mounted in outlet opening 11 in rotating fashion, where, as shown in FIG. 8, which is a cross-section along line VIII-VIII in FIG. 6, and in FIG. 6, lubricating grooves 27 provided in the longitudinal direction ensure adequate lubrication of the rotary body.

FIGS. 2 to 4 show the second practical example of linear drive unit 1, in which first transmission element 4 is designed as tube section 28, on coupling end 10 of which a further threaded bush 29 is mounted to form output section 13. Tube section 28 consists of an aluminum tube that can be cut off to obtain a desired tube section length.

As also illustrated in FIGS. 9 and 10, the two threaded bushes 29, 56 are screwed into the free end of output section 13 by screwing an externally threaded section 30 into an internally threaded section 31 provided at the end of tube section 28. Threaded bushes 29, 56 display a bush head 32 with an outside diameter equal to the outside diameter of tube section 28. Bush head 32 is axially positioned against the face end of tube section 28 in a stop position. To prevent separation of threaded bushes 29, 56 from the face end of tube section 28 as a result of rotation and simultaneous axial displacement of tube section 28, two axial pins 33 are provided, being located under tension in a face-end, axial locking hole 34. In the locking position illustrated in FIG. 2, locking hole 34 extends in axially aligned fashion through bush head 32 into the shell of tube section 28, such that axial pin 33 mounted therein connects threaded bushes 29, 56 and tube section 28 to each other in non-rotating fashion.

In this practical example, threaded bush 29 is manufactured as a plastic injection molding, and threaded bush 56 as a zinc die casting. In order to be able to reliably sink locking holes 34 into the shell of tube section 28 in the axial direction, threaded bushes 29, 56 already display blind holes 35, serving as pilot holes, before being fitted and secured on tube section 28. This is illustrated in FIG. 11. After screwing threaded bushes 29, 56 onto the respective tube section 28, in which context bush head 32 runs up against the face end of tube section 28, blind hole 35 is, as indicated in FIG. 9, extended to form locking hole 34, in which context the locking hole is sunk into the shell of tube section 28 and into interlocking threaded sections 30, 31 of tube section 28 and threaded bush 29, 56. When axial pins 33 are inserted, externally threaded section 30 and internally threaded section 31 are simultaneously blocked. FIG. 10, a face-end view of threaded bush 29, 56, shows the circumferential position of the two locking holes 34, which are located opposite each other on a peripheral circle.

Linear drive unit 1 is provided with a limit switch actuator 36 for controlling the limitation of stroke h, where limit switch actuator 36 can be moved over a switching path s, limited by limit switches 37, via first transmission element 4, i.e. via tubular nut 25 in the first practical example of linear drive unit 1, and via tube section 28 in the second practical example. To this end, limit switch actuator 36 is located in movable fashion on first transmission element 4 via a threaded bush 38. To this end, threaded bush 38 displays an internal thread 39 that engages external thread 40 provided on the rotary body, in which context threaded bush 38 is guided on the rotary body in non-rotating fashion. The pitch of internal thread 39 and external thread 40 determines the proportion of the path traveled by limit switch actuator 36 over its switching path s per revolution of the rotary body.

For non-rotating guidance of limit switch actuator 36, a projection 41 is provided that extends radially outwards from threaded bush 38 and whose free end is axially guided in a guide 42. This can particularly be seen in FIGS. 6 and 7.

FIG. 6 shows a side view of the open housing 2 of linear drive unit 1, where first transmission element 4, thrust element 5 with wire 16, worm wheel 18, and fixed bearing 22 have been omitted for greater clarity. The position of threaded bush 38 is indicated by a broken line. Guide 42 displays a guide groove 43 which, as can be seen in FIG. 7, is arranged axially in housing 2, and into which projection 41 extends radially. Projection 41 has a hexagonal cross-section, as can be seen in FIGS. 5 and 6. For guidance, two sides of projection 41, which run parallel to each other and are designed as guiding sides 44, lie against the inner walls of the groove in axially movable fashion. Pairs of the other sides of the hexagonal cross-section of projection 41 form a tip with an inclined surface that can in each case be brought into contact with limit switches 37. Limit switches 37 are designed with a spring-mounted button 45 that slides over the inclined plane when projection 41 travels over limit switch 37 and is pressed into limit switch 37, thereby triggering a signal for switching off linear drive unit 1.

Limit switches 37 are in each case fixable in any desired position on switching path s by means of an adjusting device 46. This makes it possible to set switching path s to the desired length. To this end, a guide 57 extending over switching path s is provided, displaying a slit into which a screw 48, passing through limit switch 37, can be screwed, the slit width being equal to the minor diameter of screw 48.

In FIGS. 12 to 15, side views and sectional views show a section of linear drive unit 1 with part of output section 13, which is connected to second coupling element 9. Second coupling element 9 is shown in four different embodiments in the figures.

The first embodiment of second coupling element 9, illustrated in FIGS. 12 a to c, displays a fork head 49. Fork head 49 is connected to coupling end 10 via a radial dowel pin 50, which passes radially through fork head 49 and coupling end 10 of thrust element 5, which extends into fork head 49. Perpendicular to stroke h, a connecting opening 52 is provided through both limbs 51 of the fork head to accommodate a bolt or the like (not shown) of the item of furniture (not shown). As in outlet opening 11, lubricating grooves 27 are again provided in connecting opening 52, these being arranged at intervals around the circumference on the inner side of the connecting opening, and containing lubricant (not shown). Fork head 49 is manufactured as a high-strength zinc die casting or as a plastic part. Lubricating grooves 27 ensure good sliding properties of the bolt. As can be seen in FIGS. 14 a and b, fork head 49 displays an essentially square cross-section. This permits simple cutting of threads into connecting opening 52 on a drilling machine (not shown), should this be required.

FIG. 13 shows the second embodiment of second coupling element 9, where the coupling element is provided with a lug 53 instead of the fork head. In this practical example, lug 53 is connected directly to coupling end 10 via weld 54.

FIGS. 14 a and b show side views of a third embodiment of second coupling element 9, displaying a U-section, which is likewise connected to coupling end 10 of thrust element 5 via weld 54.

FIGS. 15 a to c show a fourth embodiment of second coupling element 9, where the coupling element is fastened to coupling end 10 by screw 55.

### LIST OF REFERENCE NUMBERS

1 Linear drive unit
2 Housing
3 Transmission unit
4 First transmission element
5 Thrust element
6 External thread
7 Internal thread
8 First coupling element
9 Second coupling element
10 Coupling end
11 Outlet opening
12 Input section
13 Output section
14 Spindle
15 Internal hole
16 Wire
17 End
18 Worm wheel
19 Square
20 End
21 Wire retainer
22 Fixed bearing
23 Threaded bush
24 Banjo bolt
25 Tubular nut
26 Tubular nut head
27 Lubricating groove
28 Tube section
29 Threaded bush
30 Externally threaded section
31 Internally threaded section
32 Bush head
33 Axial pin
34 Locking hole
35 Blind hole
36 Limit switch actuator
37 Limit switch
38 Threaded bush
39 Internal thread
40 External thread
41 Projection
42 Guide
43 Guide groove
44 Guiding side
45 Button
46 Adjusting device
47 Slit
48 Screw
49 Fork head
50 Dowel pin
51 Limb
52 Connecting opening
53 Lug
54 Weld
55 Screw
56 Threaded bush
57 Guide
h Stroke
s Switching path
t Dead length

1. Linear drive unit with a linear stroke for adjusting parts mounted in movable fashion, particularly in items of furniture, having a housing, a transmission unit driven by a motor and mounted in the housing, through which a torque of a first transmission element can be converted into a linear movement of a thrust element, where the thrust element is mounted coaxially and movably relative to the first transmission element, and is provided with an external thread that engages an internal thread provided on the first transmission element, and having two coupling elements for coupling the linear drive unit to the item of furniture, where a first coupling element is connected to the housing, and a second coupling element to an end of the thrust element designed as a coupling end, and where at least the coupling end of the thrust element passes out of the housing through an outlet opening, characterized in that the first transmission element is designed as a hollow, cylindrical rotary body with an input section and an output section, and in that the output section is axially remote or offset from the input section.

2. Linear drive unit according to claim 1, characterized in that at least part of the output section of the rotary body extends from the housing through the outlet opening.

3. Linear drive unit according to claim 2, characterized in that the thrust element is located away from the housing and in non-rotating fashion in the first transmission element.

4. Linear drive unit according to claim 1, characterized in that the input section is located on one end of the rotary body, and the output section on an end of the rotary body opposite to said end.

5. Linear drive unit according to claim 1, characterized in that the thrust element is located remotely from the input section of the rotary body.

6. Linear drive unit according to claim 1, characterized in that the thrust element is designed as a spindle, mounted in non-rotating and axially movable fashion relative to the housing.

7. Linear drive unit according to claim 6, characterized in that the spindle displays an internal hole of non-circular cross-section, extending along its longitudinal axis, into which a rotation-preventing component projects that is adapted to the internal hole and connected to the housing in non-rotating fashion.

8. Linear drive unit according to claim 7, characterized in that the internal hole displays a roughly oval cross-section, and in that the rotation-preventing component is designed as a wire, particularly a welding rod, whose end projecting into the internal hole is bent over and passed back over itself.

9. Linear drive unit according to claim 8, characterized in that the end of the wire facing away from the outlet opening and leading out of the internal hole is bent over at an angle and firmly mounted in the housing in a provided wire retainer.

10. Linear drive unit according to claim 7, characterized in that the input side of the rotary body is mounted, over a bearing section, in a fixed bearing in axially immovable fashion.

11. Linear drive unit according to claim 10, characterized in that the bearing section displays a journal that passes coaxially through the fixed bearing and has a central, internal hole for passing the rotation-preventing component through the fixed bearing.

12. Linear drive unit according to claim 10, characterized in that the bearing section of the rotary body is connected to the fixed bearing via a banjo bolt, which passes coaxially through the fixed bearing and has a central, internal hole for passing the rotation-preventing component through the fixed bearing.

13. Linear drive unit according to claim 1, characterized in that the rotary body is designed as a one-piece tubular nut.

14. Linear drive unit according to claim 13, characterized in that the internal thread in the output section of the tubular nut extends up to the input section as a maximum.

15. Linear drive unit according to claim 13, characterized in that the rotary body is designed as a tube section.

16. Linear drive unit according to claim 15, characterized in that one or both ends of the tube section display a threaded bush fitted on the face end.

17. Linear drive unit according to claim 16, characterized in that the threaded bush is screwed into the respective end of the tube section by screwing an externally threaded section into an internally threaded section provided at the end of the tube section.

18. Linear drive unit according to claim 16, characterized in that the threaded bush displays a bush head with an outside diameter that is greater than, or equal to, the outside diameter of the tube section, by means of which the threaded bush is axially guided into a stop position against the face end of the tube section.

19. Linear drive unit according to claim 16, characterized in that, to prevent rotation of the threaded bush, at least one axial pin or the like is provided, and in that the axial pin is located in a face-end, axial locking hole, which extends from the bush head into the shell of the tube section when in locking position.

20. Linear drive unit according to claim 16, characterized in that the threaded bush mounted on the one end of the tube section displays an internal thread to form the output section.

21. Linear drive unit according to claim 16, characterized in that the threaded bush mounted on the other end of the tube section is designed as a bearing section.

22. Linear drive unit according to claim 16, characterized in that the threaded bush is manufactured as a plastic injection molding.

23. Linear drive unit according to claim 1, characterized in that a limit switch actuator is provided for limiting the stroke.

24. Linear drive unit according to claim 23, characterized in that the limit switch actuator is movable on the rotary body over a switching path limited by limit switches, where the limit switch actuator displays a threaded bush with an internal thread, by means of which the threaded bush engages an external thread provided on the rotary body, and is guided on the rotary body in non-rotating fashion.

25. Linear drive unit according to claim 23, characterized in that the limit switch actuator displays a projection that extends radially outwards from the threaded bush and whose free end is guided axially in a guide provided.

26. Linear drive unit according to claim 25, characterized in that the free end of the projection can be moved against the limit switches to actuate the limit switch.

27. Linear drive unit according to claim 25, characterized in that the guide displays an axial guide groove, and in that the projection displays a cross-section with two sides that run parallel to each other and are designed as guiding sides lying laterally against the inner walls of the guide groove in axially movable fashion.

28. Linear drive unit according to claim 25, characterized in that the projection displays, laterally and in both directions of the switching path, a side face for actuating the limit switches that is arranged at an acute angle to the switching path.

29. Linear drive unit according to claim 25, characterized in that the limit switches are in each case fixable in any desired position on the switching path by means of an adjusting device provided.

30. Linear drive unit according to claim 29, characterized in that the limit switches are guided in an axial guide extending over the switching path.

31. Linear drive unit according to claim 30, characterized in that the guide displays a slit, and in that the limit switches can in each case be fixed in the slit by a screw connection.

32. Linear drive unit according to claim 1, characterized in that the second coupling element displays a fork head or a lug with a connecting element for connection to the item of furniture that is fastened to the coupling end in non-rotating and non-sliding fashion.

33. Linear drive unit according to claim 32, characterized in that the connecting element is provided with a connecting opening for accommodating a bolt or the like of the item of furniture.

34. Linear drive unit according to claim 1, characterized in that the input side of the first transmission element is driven by a second transmission element, which is arranged coaxially to the first transmission element and which overlaps the first transmission element, at least over an end section, and is connected to the first transmission element in non-rotating fashion.

35. Linear drive unit according to claim 34, characterized in that, on the side facing towards the lateral area of the first transmission element, the second transmission element displays at least one extension, projecting radially inwards, by means of which the second transmission element engages a correspondingly adapted recess in the cylindrical shell of the first transmission element.

36. Linear drive unit according to claim 34, characterized in that the second transmission element is designed as a worm wheel that engages a worm arranged at right angles to its axis of rotation, where the axes of rotation of the worm and the motor run in the same direction.
